(19) United States
(12) Patent Application Publication
(10) Pub. No.: US 2005/0168312 A1
(43) Pub. Date: Aug. 4, 2005

(54) Transformer

(76) Inventor: Uwe Mandler, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/505,503

(22) PCT Filed: Jan. 28, 2003
(86) PCT No.: PCT/IB03/00302

(30) Foreign Application Priority Data
Feb. 28, 2002 (EP) 02075806.6

(51) Int. Cl. G11B 5/027

(52) U.S. Cl. 336/83

(57) ABSTRACT

The invention relates to a transformer including a drum core (1) of a magnetic material with an intermediate central core shaft (4) and a flange portion (5) at each end of the core shaft. An insulated primary wire (2) is wound closest to the central core shaft and an insulated secondary wire (3) is wound on the outside of the primary wire. At least one of the flange portions (5) is provided with an element (12, 15) of an electric insulating material, which element prevents the wires from coming into contact with the peripheral surface of the flange portion when crossing the flange portion radically from the central core shaft. The element can be formed as a peripheral element (12) which at least partially covers an outer peripheral surface of the flange portion. The element can also be formed as a slot-forming element (15) on an inner surface of at least one of the flange portions (5). The slot-forming element (15) comprises two wall portions (15′, 15″) between which a slot (16) is defined; and in at least the wall portion (15′) , which faces away from the inner surface of the flange portion, a recess is formed extending from the periphery to at least the vicinity of the core shaft (4) to allow wire routing through the slot (16). Preferably the peripheral element (12) and the slot-forming element (15) are combined on a drum core (1) and preferably constitute a single unitary unit.

The present invention relates to a transformer including a drum core of a magnetic material, preferably ferrite, with an intermediate central core shaft and a flange portion at each end of the core shaft, an insulated primary wire being wound as close as possible to the central core shaft and an insulated secondary wire being wound on the outside of the primary wire on the central core shaft.

Especially in electrical applications and apparatuses with a power-consumption of up to about 2 W, there is a need for low-cost transformers to transform the mains voltage from a mains voltage outlet to a voltage adapted to the apparatus. A commonly known way to obtain such a transformer is to design it in accordance with the transformer mentioned in the introductory part. Such a transformer is easy to manufacture due to the fact that it is composed of few parts and it can be assembled in a labor-saving manner. The drum core can easily be formed through an inexpensive moulding and pressing process. The primary and secondary wires are wound on a common, central drum shaft, whereas the flange portions at each end of the drum shaft, in addition to contributing to the overall magnetic characteristics of the drum core, retain and protect the windings.

However, when routing the connection leads of the wires to and from the transformer is problematic since, one way or than other, the connection leads have to pass the flange portions to be connected to connecting pins, terminals or the like. The edges around the flange portions are often very sharp which may damage the insulation on the wires when they are bent over the edges. This can lead to short-circuits or possibly serious injuries and even to the death of a user of the apparatus if parts of the apparatus that can be touched accidentally carry an electric voltage. One way to overcome this problem would be to use flying connection leads, which do not touch the flange portions, but such flying leads are sensitive and are easily damaged.

Moreover, there are safety regulations prescribing that contacting primary and secondary wires must not cross each other at an angle >45°. The reason for this is that in the case of a large-angle crossing, the bearing surface area between two wires will be very small, which might lead to high bearing pressure between the wires and possible damage to the insulation and consequently short circuiting or hazardous voltages on parts of the apparatus that can be touched. Unfortunately this situation holds for the routing of the connection leads of the primary wire, leading to and from the primary winding, which have to cross the secondary wire in the region between the flange portion of the drum core and the secondary winding. One way to overcome this problem is to put a barrier tape between the two crossing wires. However, applying such a tape is labor-intensive or requires a complex and expensive winding machine. Another way to overcome the problem is to provide the flange portions of the drum core with grooves extending from the peripheral edge to the central core shaft. In this way the primary wire can be routed to and from the primary winding without crossing the secondary wire. However, the problem of the connection leads having to pass possible sharp edges of the flange portions still exists.

In JP 09045547 is disclosed a transformer comprising a drum core on which a primary and a secondary winding are provided. The drum core is provided with a groove, extending from the peripheral edge of at least one flange portion to the central core shaft, through which the connection leads may be routed. To protect the connection leads and prevent them from coming into contact with the edges of the groove in the flange portion, a base applied on the outside of the flange portion has a protrusion that extends into the groove and covers the edge of the groove up to a level flush with the inner surface of the flange portion. The protrusion is formed with rounded edges which do not cause damage to the insulation on the wires. However, with a transformer designed in this way, the manufacturer is obliged to route the connection leads through the groove and does not have the option to route one or more of the connection leads radially past the peripheral edges of the flange portions even if this would be more favorable in respect of the location of connecting pins, terminals or the like.

The object of the present invention is to improve prior art transformers of the drum core type. More specifically, in accordance with a first aspect of the invention, it is an object to protect the connection leads to and from the central core shaft of drum core transformers, and prevent that their insulation layers are damaged by the edges of the flange portions, while, in addition, the connection leads can be routed in optional directions. At least this object is achieved with a transformer according to claim 1.

According to a second aspect of the invention, it is an object to allow the connection leads of the primary as well as the secondary wires to be radially routed over the peripheral edge of the flange portion, without the connection leads in contact with each other crossing at angles >45°. At least this object is achieved with a transformer according to claim 6.

The object according to the first aspect can be achieved in different ways. One way in which this can be achieved, according to claim 2, is by at least partially covering the outer peripheral surface of the flange portion with a peripheral element. Another way in which this can be achieved, according to claim 6, is by arranging a slot-forming element on an inner surface of the flange portion. In both ways it is possible to route the connection leads in any optional direction from the transformer and yet prevent the insulation on the wires from being damaged by the edges of the drum core flange portions, thereby precluding short circuits and/or injury.

Although it is preferred, for the sake of simplicity and better magnetic characteristics, to use a drum core which is formed with homogeneous flange portions without any grooves in them, within the scope of the invention, use can also be made of drum cores provided with grooves. In this case also the surface of the grooves is covered with an electrically insulating material by the peripheral element to prevent the insulation on the wires from being damaged by the edges of the groove. One advantage of such an embodiment is that at least the connection leads of the primary wire may be routed through the groove and thereby prevent crossing of the wires at an angle >45°.

The peripheral element could e.g. be formed as a collar or sleeve which is simply threaded around the flange portion. In a preferred embodiment, however, the peripheral element is formed as a cap or cover which, in addition to the peripheral surfaces of the flange portion, also covers the outside or the bottom side of the flange portion. Such a cover can moreover function as an attachment for the transformer on a substrate, e.g. a circuit board.

According to the second aspect, the invention is based on the recognition that crossing of the wires in contact with each other at an angle >45° is prevented, even if use is made of a drum core with homogeneous flange portions without any groove, if a slot-forming element, preferably of an electrically insulating material, is located on the inside of at least one of the flange portions. A recess is formed in at least that one of the two wall portions forming part of the slot-forming element which faces away from the flange portion. This allows the connection leads to and from the transformer, and in particular the connection leads of the primary wire, to be routed through the slot and through the recess so as to be wound on the central core shaft.

To enable simple mounting of the slot-forming element on the central core shaft, both wall portions, in a preferred embodiment of the invention, are formed with a recess, each recess having a width that is at least equal to the outside diameter of the central core shaft. Hereby the slot-forming element can be slidably pushed around the central core shaft. However, it would also be conceivable that the slot-forming element can be divided into two halves, which are assembled around the central core shaft in any suitably way.

In a preferred embodiment, at least the wall portion of the slot-forming element, which is placed against the flange portion, has a width that is at least equal to the diameter of the flange portion. In this way the connection leads can be routed to the transformer without any contact at all with the flange portion, and the peripheral edge of the wall portion is preferably also rounded so as not to damage the insulation of the wires.

Preferably the slot-forming element and the peripheral element are combined, either as a single unitary unit or as two or more separate units which are assembled in any suitably way.

The invention will now be explained with reference to the embodiments described hereinafter and the accompanying drawings in which:

FIG. 1 is a perspective view of a first embodiment of a prior art drum core provided with a groove in one of the flange portions, with a connection lead to the primary and secondary windings, respectively, being schematically indicated;

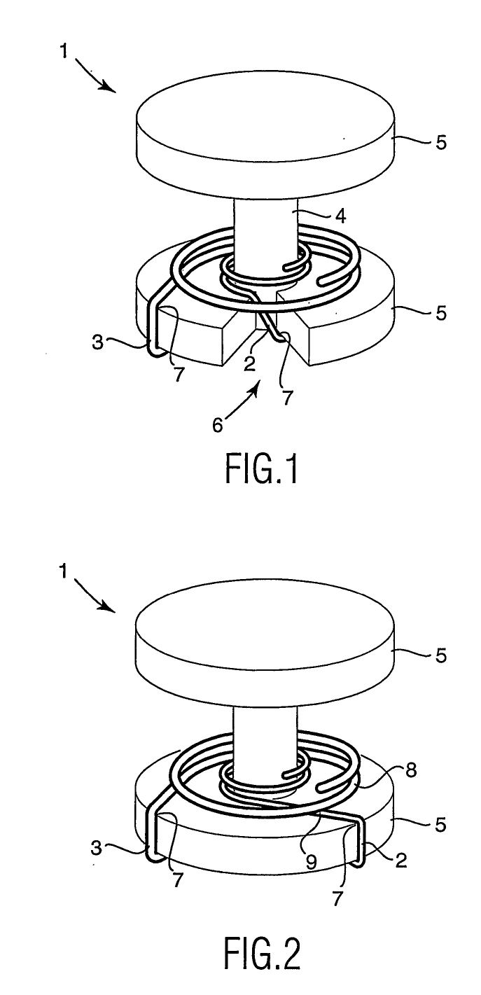

FIG. 2 is a perspective view according to FIG. 1 of a second embodiment of a prior art drum core without a groove in the flange portions;

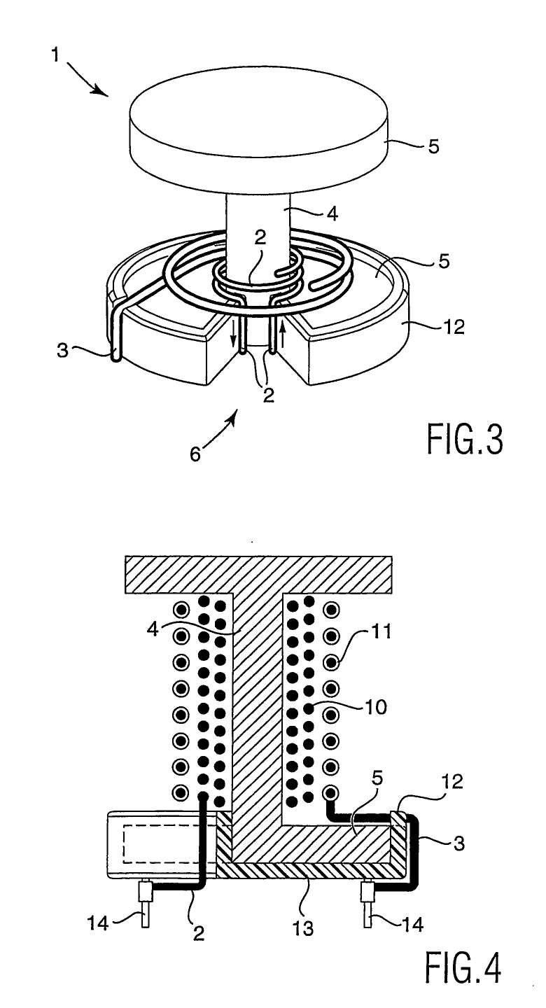

FIG. 3 is a perspective view of the drum core in FIG. 1, wherein a protective cover including a peripheral element according to the invention is applied on to one of the flange portions;

FIG. 4 is a cross-sectional view through the center of the drum core in FIG. 3;

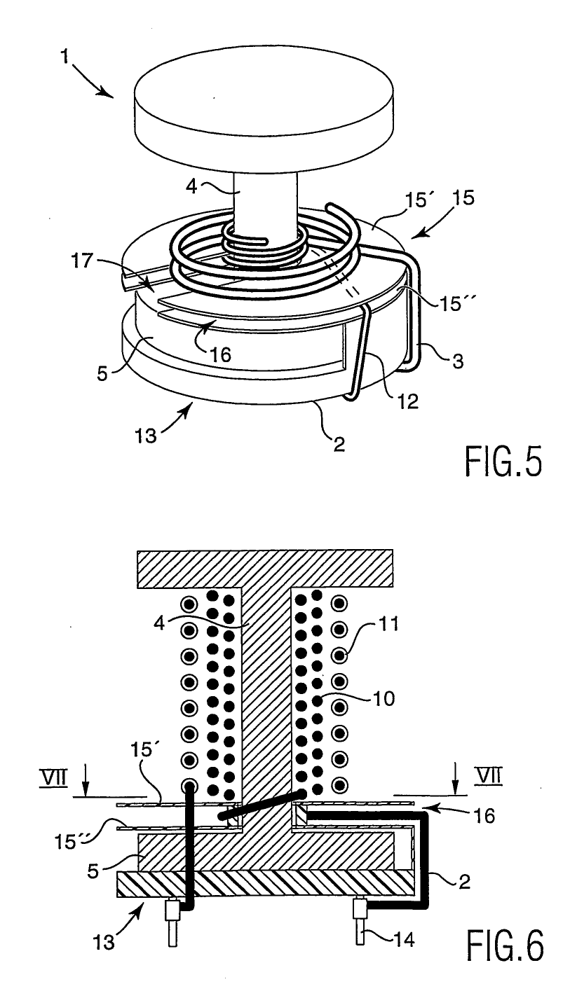

FIG. 5 is a perspective view of the drum core in FIG. 2, wherein a protective cover including a peripheral element and a slot-forming element according to the invention is applied on to one of the flange portions;

FIG. 6 is a cross sectional view through the center of the drum core in FIG. 5;

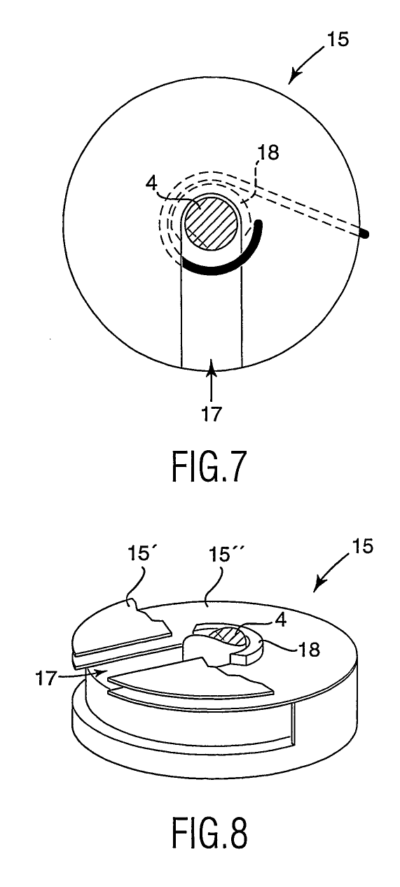

FIG. 7 is a cross sectional view along the line VII-VII in FIG. 6; and

FIG. 8 is a perspective view of the slot-forming, peripheral element in FIG. 6.

For a better understanding of the problems in regard to the routing of the connection leads of the primary and secondary wires to and from a transformer of a drum core type, reference is first made to FIGS. 1 and 2 of the drawings. In these Figures are depicted two types of conventional prior art drum cores 1, with a connection lead of a primary 2 as well as a secondary 3 wire being schematically illustrated. The drum core 1 comprises a central core shaft 4 and a flange portion 5 at each end of the central core shaft 4.

The drum core in FIG. 1 is provided, in one of its flange portions, with a groove 6 which is generally V-shaped and extends from the outer peripheral surface of the flange portion to the vicinity of the central core shaft 4. The connection lead of the primary wire 2, which will be wound on the central core shaft to form a primary winding as close as possible to the central core shaft, is routed through the groove 6. The connection lead of the secondary wire 3, which will be wound on the primary winding to form a secondary winding on the outside of the primary winding, could also be routed through the groove 6, but in this embodiment is routed radially over the flange portion 5 and bent over the peripheral edge of the flange portion, since this is sometimes preferable in respect of the localization of connection pins, terminals and the like. In this prior art transformer, problems may arise at the spots indicated by means of reference numeral 7 where the connection leads are bent over the sharp edges of the periphery of the flange portion and the boundaries of the groove, since the insulation on the wires may be damaged resulting in short-circuits and/or injuries as mentioned before.

Unlike the drum core in FIG. 1, the drum core in FIG. 2 does not have any groove. Instead the connection leads of both the primary 2 and the secondary 3 wire are routed radially over the flange portion 5 and bent over the sharp edge of its periphery so that, like in FIG. 1, problems may arise in the spots 7. Furthermore, in this embodiment the connection lead 2 to the primary winding has to run in a region between the secondary winding (illustrated by one turn 8 of the winding) and the inner surface of the flange portion 5. In most cases this means that the primary and the secondary wires will cross each other (spot 9) at an angle >45° which, in addition to the fact that it may damage the insulation of the wire, is not allowed due to certain security regulations.

Now reference is made to FIGS. 3 and 4 where a first embodiment of the invention is illustrated. The drum core in this embodiment is of the same type as the drum core in FIG. 1, i.e. it is formed with a groove 6 in one of its flange portions 5. As in FIG. 1, the connection leads 2 to a primary winding 10 are routed through the groove 6, whereas the connection leads 3 to a secondary winding are routed radially over the flange portion 5 of the drum core and bent over the edge of the flange portion. However, according to the invention, the drum core is provided with a peripheral element 12 of an electrically insulating material covering the entire peripheral surface of the flange portion as well as the surface portions of the groove 6. More specifically, the peripheral element forms part of a cover 13 which is thread on one end of the drum core so that it covers the outside or the bottom side of the flange portion. The peripheral element 12 can easily be manufactured with rounded edges, thus reducing the risk of damage to the wire insulation, but if the insulation should nevertheless be damaged, the electrically insulating material will prevent short-circuits and/or injury. As is evident from FIG. 4, the upper edge of the peripheral element 12 in the preferred embodiment is slightly higher than the inner surface of flange portion 5. This additionally reduces the risk of short-circuits and/or injury since the connection leads can be routed to the primary and secondary windings 10, 11 without touching the flange portion at all. To help secure the connection leads, the upper edge of the peripheral element is provided with a notch at the intended passage of the connection lead over the edge of the flange portion.

In the preferred embodiment, the cover 13 also functions as an attachment for the transformer on a printed circuit board or the like. Connection pins 14 on the bottom side of the cover form electrical connection terminals for the wires as well as fasteners for the transformer and are to be inserted into mating sockets at the circuit board.

FIGS. 5 and 6 show a second embodiment of the invention, especially adapted for a drum core, without a groove, according to FIG. 2. In addition to a peripheral portion 12, this embodiment also comprises a slot-forming element 15, including two wall portions 15′ and 15″, between which a slot 16 is defined.

In the preferred embodiment, the peripheral element 12 forms part of a cover 13, which covers the outside or bottom side of the flange portion 5 and functions as an attachment for the transformer as well. Furthermore, the cover and the slot-forming element 15 are integrated into a single unit. To facilitate mounting on the drum core, the peripheral element 12 does not extend around the entire circumference of the flange portion 5, but only around about half the circumference. For the same reason the slot-forming element 15 is provided with a recess 17 the width of which is at least equal to the diameter of the central core shaft 4. A device formed in this way can readily be mounted on the drum core by slidably moving it over the flange portion 5.

Furthermore, by means of the device the routing of the connection leads of the primary 2 and the secondary 3 wire can be performed in a safe and reliably manner. The primary wire 2 is routed from a connection pin 14 on the bottom side of the cover 13 on the outside of the peripheral element 12, through the slot 16 for less than one turn and finally upwards through the recess 17 in the upper wall portion 15′ to be wound on the central core shaft 4 as a primary winding. The secondary wire 3, on the other hand, is routed from a connection pin 14, on the outside of the peripheral element 12 and radially over the upper side of the slot-forming element 15 to be wound as a secondary winding on the primary winding. In this way there is no contact at all between the wires and the flange portion, and the primary and secondary wires do not cross so as to be in contact with each other.

In FIGS. 7 and 8 the combined slot-forming and peripheral element 15 is shown in more detail in cross-section and in perspective, respectively. As can be seen from the drawings, the two wall portions 15′ and 15″ are held at a distance from each other by a distance element 18 which is curved and located around the center of the wall portion. To be precise, it is semicircular and open on the side of the recesses 17 to allow it to be slideably moved around the central core shaft 4.

As mentioned hereinabove, it is preferred to combine the slot-forming element 15 with a peripheral element 12 as in FIGS. 5-8. However it would also be possible to use it separately, i.e. without any peripheral element. In that case, at least the wall portion 15″ closest to the flange portion 5 has a width, over at least part of its circumference, which is at least equal to the diameter of the flange portion. In this way the connection leads can be routed to the transformer without contacting the flange portion, and the peripheral edge of the wall portion is preferably also rounded so as not to damage the insulation of the wires.

In summary, the invention relates to a transformer including a drum core 1 of a magnetic material with an intermediate central core shaft 4 and a flange portion 5 at each end of the core shaft. An insulated primary wire 2 is wound closest to the central core shaft and an insulated secondary wire 3 is wound on the outside of the primary wire. At least one of the flange portions 5 is provided with an element 12, 15 of an electrically insulating material, which element prevents the wires from coming into contact with the peripheral surface of the flange portion when crossing the flange portion radially from the central core shaft. The element can be formed as a peripheral element 12 which at least partially covers an outer peripheral surface of the flange portion. The element can also be formed as a slot-forming element 15 on an inner surface of at least one of the flange portions 5. The slot-forming element 15 comprises two wall portions 15′, 15″ between which a slot 16 is defined; and in at least the wall portion 15′, which faces away from the inner surface of the flange portion, a recess is formed extending from the periphery to at least the vicinity of the core shaft 4 to allow wire routing through the slot 16. Preferably the peripheral element 12 and the slot-forming element 15 are combined on a drum core 1 and preferably constitute a single unitary unit.

1. Transformer including a drum core (1) of a magnetic material with an intermediate central core shaft (4) and a flange portion (5) at each end of the core shaft, an insulated primary wire (2) being wound as close as possible to the central core shaft and an insulated secondary wire (3) being wound on the outside of the primary wire on the central core shaft, characterized in that, at least one of the flange portions (5) is provided with an element (12, 15) of an electrically insulating material, which element prevents the wires from coming into contact with the peripheral surface of the flange portion when crossing the flange portion radially from the central core shaft.

2. Transformer according to claim 1, characterized in that at least one of the flange portions (5) is provided with a peripheral element (12) of an electrically insulating material which at least partially covers an outer peripheral surface of the flange portion in such a way that the wires (2, 3) are prevented from coming into contact with the peripheral surface of the drum core flange portion when crossing the flange portion radially from the central core shaft (4).

3. Transformer according to claim 2, characterized in that the drum core (1) is formed with at least one groove (6) extending from the peripheral surface of the flange portion (5), wherein the peripheral element (12) also covers the surface of the groove.

4. Transformer according to claim 2, characterized in that the peripheral element (12) protrudes from an inner surface of the flange portion (5).

5. Transformer according to claim 2, characterized in that the peripheral element (12) forms part of a cover (13) covering the outside or the bottom side of the flange portion (5).

6. Transformer according to claim 1, characterized in that it is provided with a slot-forming element (15) of an electrically insulating material on an inner surface of at least one of the flange portions (5), the slot-forming element comprising two wall portions (15′, 15″) between which a slot (16) is defined, and in at least the wall portion (15′) which faces away from the inner surface of the flange portion, a recess is formed extending from the periphery to at least the vicinity of the core shaft (4) to allow wire routing of at least the primary wire (2) through the slot (16), across the flange portion and out of the slot through the recess (17) to be wound on the central core shaft (4).

7. Transformer according to claim 6, characterized in that a recess (17) is formed in each of the wall portions (15′, 15″), which recesses both extend from the periphery to the center and are at least as wide as the diameter of the central core shaft (4), allowing the slot-forming element (15) to be applicable around the central core shaft.
